(19) United States
(12) Patent Application Publication
(10) Pub. No.: US 2014/0257838 A1
(43) Pub. Date: Sep. 11, 2014

(54) Patient Care plan determination

(71) Applicant: Siemens Technology and Services Pvt. Ltd., Worli (IN)

(72) Inventors: Damodar Karra, Bangalore (IN); Ramachandran Koduvayur Bala, Tirupati (IN)

(73) Assignee: Siemens Technology and Services Pvt. Ltd., Worli (IN)

(21) Appl. No.: 14/199,162

(22) Filed: Mar. 6, 2014

Related U.S. Application Data
(60) Provisional application No. 61/773,906, filed on Mar. 7, 2013.

(51) Int. Cl. G06Q 50/22; G06Q 10/10

(52) U.S. Cl. CPC G06Q 50/22; G06Q 10/10
USPC 705/2

(57) ABSTRACT

Patient characteristics as well as cost and quality measures may be used to determine a suitable care plan for a patient having a particular medical condition from a collection of care plans. The patient characteristics may be used to initially filter the care plans to meet basic topical characteristics of the patient such as gender or age. Care plans may be further filtered based on other characteristics such as insurance applicability, performance measures, and cost characteristics of specific care plans. Care plans passing through the various filters may be provided to a user such that pertinent information such as cost, frequency, and effectiveness of care for each filtered plan may be displayed. A user then may have sufficient information available to select an appropriate care plan for the specific patient.

### RELATED APPLICATIONS

The present patent document claims the benefit of the filing date under 35 U.S.C. §119(e) of Provisional U.S. Patent Application Ser. No. 61/773,906, filed Mar. 7, 2013, which is hereby incorporated by reference in its entirety.

### FIELD

The present embodiments relate to patient care plan determination. Specifically, the present embodiments relate to determining patient care plan options automatically using patient and facility characteristics as well as cost and quality data.

### BACKGROUND

There are variations in many aspects of healthcare delivery and also in clinical workflows for given health conditions. There are many factors that contribute to these variations. Some of the variations are due to the characteristics of individual patients, or differences in the capabilities and experience of physicians or other health care providers of a health care facility.

These significant variations in healthcare delivery often cause the creation of treatment plans for specific patients to be cumbersome as each patient, facility, and care provider characteristic, as they relate to care plan options, are taken into account. Care planning is important in healthcare delivery as without a document delineating a plan of care, important issues may be neglected. Care planning may provide a road map to guide those involved with a patient's care. A care planning process involves multiple disciplines and organizational or facility functions that may be involved with the patient's care. Further, some functions, such as billing or quality measurement, may not be involved with the actual creation of a care plan.

The multitude of factors involved in determining a care plan can cause the manual creation of patient care plans to be inefficient and time consuming for a health care system user in a facility.

### BRIEF SUMMARY

By way of introduction, the preferred embodiments described below include methods, computer readable media, and systems for patient care plan determination. To facilitate care plan determination, patient topical and clinical characteristics are matched to care plans to provide options for the care of the patient. Further, cost, quality, and insurance eligibility for the patient may be displayed with the matched care plans such that a user will have sufficient data to select an appropriate care plan for the patient.

In a first aspect, a method is provided for patient care plan determination for a patient. The method may involve identifying at least one patient care plan from a plurality of patient care plans based on topical characteristics of the patient, wherein the plurality of patient care plans comprise care plan components and care plan characteristics, the care plan characteristics comprise an indicated effectiveness for treating conditions, and the care plan components are associated with a cost, designating at least one identified care plan as a candidate care plan when at least one patient care plan characteristic matches at least one clinical characteristic of the patient, assessing the compatibility of the at least one candidate care plan with the patient, determining a cost of the at least one candidate care plan deemed to be compatible with the patient, the cost based on the costs of the care plan components, and providing in real-time the at least one compatible candidate care plan to a user, the providing comprising providing the indicated effectiveness for treating conditions of the candidate care plan and associated cost of the candidate care plan.

In a second aspect, a non-transitory computer readable storage medium is provided having stored therein data representing instructions executable by a programmed processor for preparation of a data set for patient care plan determination for a patient. The storage medium having instructions for identifying at least one patient care plan from a plurality of patient care plans based on topical characteristics of the patient, wherein the plurality of patient care plans comprise care plan components and care plan characteristics and the care plan components are associated with a cost, designating at least one identified care plan as a candidate care plan when at least one patient care plan characteristic matches at least one clinical characteristic of the patient, assessing the compatibility of the at least one candidate care plan with the patient, and providing the at least one compatible candidate care plan and associated cost to a user.

In a third aspect, a system is provided for patient care plan determination. The system involves at least one repository of historical treatment data comprising a plurality of care plans and associated treatment objectives and treatment costs and diagnoses associated with clinical quality indicators and costs. The system also involves a care plan processor for automatically using the historical treatment data in selecting candidate care plans for treating a diagnosed condition of a patient in response to the clinical quality indicators, analyzing the selected care plans to identify a medication interaction and a conflict with a patient allergy, identifying candidate alternative medications using predetermined data identifying medications and their alternatives, and using the historical treatment data in identifying costs of individual procedures and medications of the selected care plans and the alternatives. The system may also involve an output processor for providing message data to a user identifying the selected care plans and the alternatives and costs of individual procedures and medications and the alternatives.

In a fourth aspect, a patient care plan determination system is provided. The system involves at least one repository of historical treatment data comprising a plurality of care plans and associated treatment objectives and treatment costs and diagnoses associated with clinical quality indicators and costs. The system also involves a care plan processor for using the historical treatment data in selecting candidate care plans for treating a diagnosed condition of a patient in response to the historical treatment data indicating a care plan of treatment brings a patient tested parameter to a normal value for patients having the condition, using the historical treatment data in identifying costs of individual procedure components and medication components of the selected care plans, initiating insurance eligibility verification for the patient for the selected care plans and costs of individual procedure components and medication components. The system may also involve an output processor for providing message data to a user identifying the selected care plans and the alternatives and costs of individual procedure components and medication components and the alternative components.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 shows a flow chart diagram of one embodiment of a method for patient care plan determination;

FIG. 2 illustrates an embodiment of patient care plan determination;

FIG. 3 shows a flow chart diagram of one embodiment of a method for patient care plan determination; and

FIG. 4 provides an illustrative embodiment of a computer system for preparation of a data set for healthcare system development.

### DETAILED DESCRIPTION OF THE DRAWINGS AND PRESENTLY PREFERRED EMBODIMENTS

Patient care plans may be determined using the characteristics of the patient to filter a collection of patient care plans, providing care plans particularly suited to a patient. Further, additional patient characteristics may be used after the initial filtering to narrow the provided care plans to plans particularly suited to the patient and the patient's clinical needs. For example, insurance information relating to the patient may be used to further filter the provided care plans such that an indication as to whether the patient's insurance covers the components of a care plan may be provided. Ultimately, a listing of filtered care plans may be provided to a user. The care plans are associated with costs and/or effectiveness measures derived from historical patient data of a facility. Thus, the costs and effectiveness of the various care plans as related specifically to a patient may be available at the point of care. One of these care plans is chosen for a patient.

A care plan derivation process may involve multi-stage processing of data available in a central data repository based on different patient, clinical, topical, facility, billing, and quality measure characteristics. A care plan derivation may provide optimal treatment and cost effective care plans for a particular patient and/or patient medical condition in response to cost and quality indicator measures. A care plan derivation process may derive a list of care plans for a patient in context, taking into account characteristics and analyzing historical data available in a central data repository or database. In essence, a care plan derivation may be processed through multiple stages to arrive at a list of selectable care plans for a particular patient.

In an embodiment, a system may derive and suggest suitable care plans and alternatives for each care plan component by utilizing historical treatment information shared among various healthcare providers. The suitable care plan determinations may be based on various characteristics including clinical, insurance, billing, cost and/or quality measures.

In an embodiment, a system may facilitate achievement of accountability requirements for patient care by meeting regulatory quality indicators and measures as care plans are derived based on these aspects. The system may use quality indicators at a patient level while deriving or selecting care plans. The system may improve provision of cost effective treatment and interact with insurance agencies to reduce delays in providing insurance approval as the care plan is derived with consideration of treatment eligibility and cost. A healthcare provider may have the option to choose alternatives among available care plans to minimize the cost of treatment. Further, the system may be integrated with other health information systems, or operate as a stand-alone system. In an embodiment, a system is used by multiple different organizations providing treatment plan consistency across the different organizations as well as improved patient safety and facility accountability.

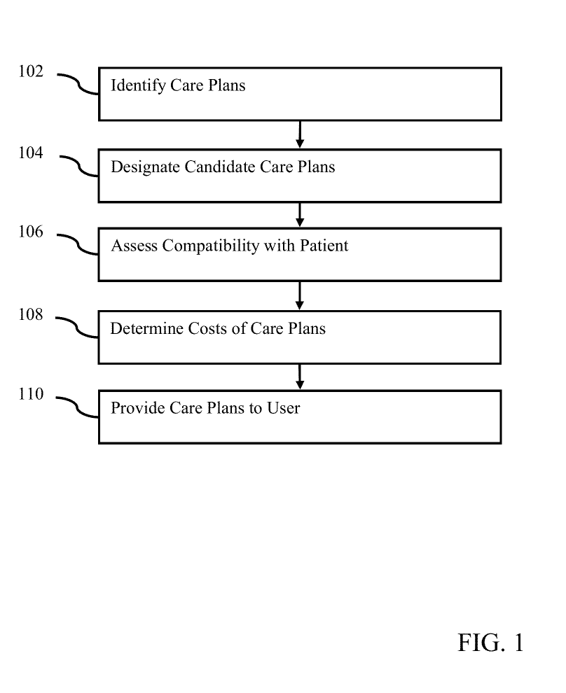

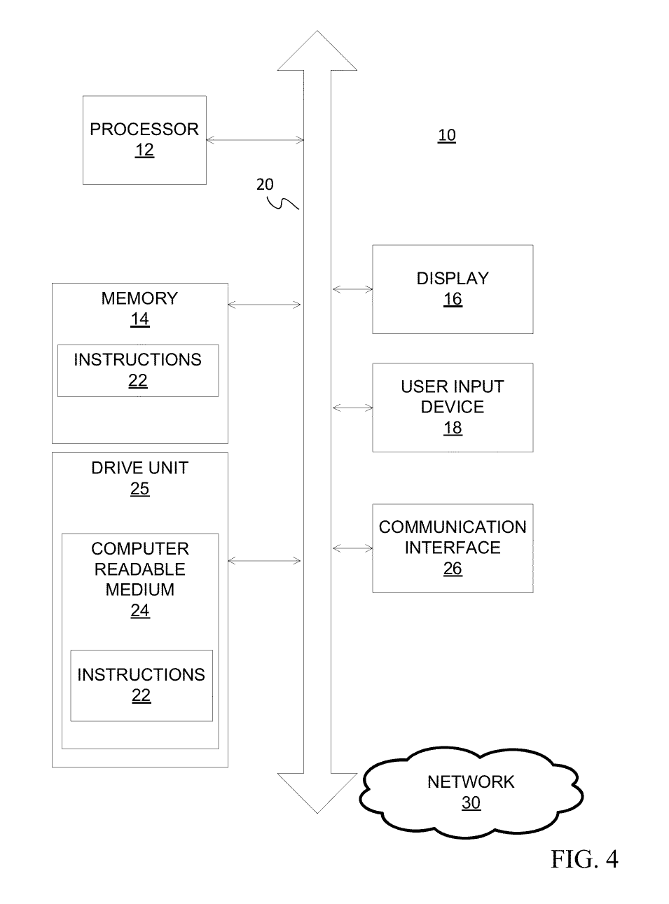

FIG. 1 shows a flow chart diagram of one embodiment of a method for patient care plan determination. The method is implemented by a healthcare system such as a computerized physician order entry (CPOE) system, an automated workflow system, a review station, a workstation, a computer, a picture archiving and communication system (PACS) station, a server, combinations thereof, or other system in or associated with a medical facility. For example, the system, processor, and/or computer readable media illustrated in FIG. 4 implements the method, but other systems may be used.

An electronic health system may be any computer system involving the storage, entry, or manipulation of health data. For example, an electronic health system may be used by health facilities, insurance companies, or any other type of company working with confidential patient data.

Additional, different, or fewer acts may be performed. For example, an act for selecting a care plan from a list of care plans may be added. Further, an act for implementing a selected care plan with an electronic health system may be added. In another example, act 110 may be omitted or replaced with a different act. The method is implemented in the order shown or a different order. For example, acts 104, 106, and/or 108 may be performed in parallel or repeated. In another example, act 108 may be performed before acts 102, 104, or 106.

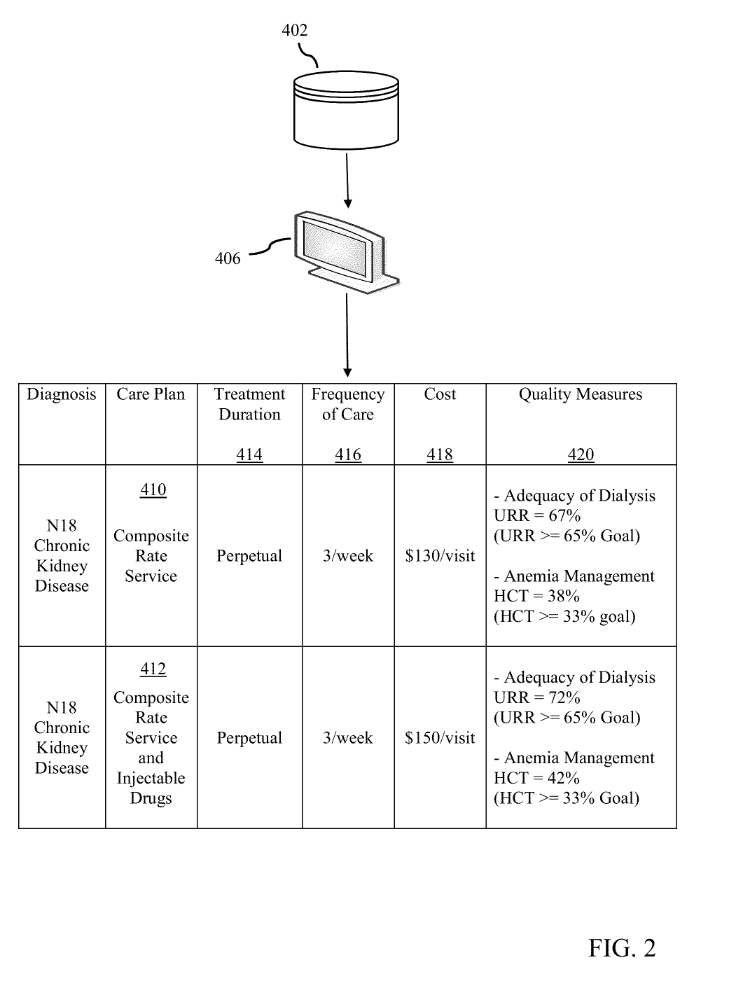

In act 102, patient care plans may be identified from a collection of patient care plans. The collection of patient care plans may involve care plan components and care plan characteristics. The care plan characteristics may involve an indicated effectiveness for treating conditions, as is indicated in the quality measures 420 of the care plans 410 and 412 of FIG. 2. The care plan components may be associated with a cost.

Care plans may be identified based on topical characteristics of a patient. For example, a care plan may be associated with topical characteristics for which the care plan is applicable, and care plans having applicable topical characteristics that match the patient topical characteristics may be identified. Topical characteristics may include any characteristic of a patient related to the general status or existence of a patient. For example, topical characteristics may involve an age, gender, ethnicity, basic physiological findings such as height or weight, mobility of a patient, general patient habits such as alcohol intake, the geographical location of a patient, or any other basic or demographic data relating to a patient. For example, care plans associated with male patients may be identified when the patient topical characteristics indicate that the patient is male. In an embodiment, the care plans may be identified only if the care plan characteristics match both the age and gender of a patient.

A care plan may be any collection of data relating to the specific planned treatment of a patient. For example, care plans may be a collection of components designated to treat a particular condition, such as chronic kidney disease as indicated in the care plans 410, 412 of FIG. 2. In an embodiment, a care plan may be considered a personalized plan that details a patient's intended path of care for a diagnosed condition. Care plans may be pre-constituted such that they are standardized for particular conditions. Alternately, care plans may be modular such that care plan components may be assembled as needed or desired based on a patient's intended course of care.

A care plan component may be any part of a care plan. For example, care plan components may involve actions or items involved in the treatment or care of a patient. For example, dialysis and injectable drugs may be components for a care plan 412 associated with the treatment of chronic kidney disease in a patient, as is indicated in FIG. 2. Other examples of components may include computed tomography (“CT”) sessions, X-ray imaging session, laboratory testing, doctor progress evaluations, other medical procedures, prescription or other drug intake, radiological evaluations, other specialist evaluations, or any other indicated component intended as a part of a process for providing healthcare for a patient.

Care plan components may have associated costs. The associated costs may vary based on applicable insurance plans related to a patient undertaking the care plan component. Further, care plan component costs may be costs derived from historical data relating to the treatment of patients at a particular facility, or a collection of facilities. In an embodiment, the component costs may be derived from historical data relating to the treatment of patients at the facility providing treatment for the patient having a care plan determined for them. Further, component costs may be derived from historical data relating to the treatment of patients having a same or similar insurance coverage as the patient.

Care plan characteristics may be any characteristic related to the appropriate implementation of a care plan. For example, care plan characteristics may involve associated insurance coverage for the care plan, appropriate demographic applicability, topical patient characteristics applicability, associated historical performance statistics of the care plan such as statistical performance verses goals for performance measurement, as well as any other characteristic related to the applicability or performance of the care plan. Further, care plan characteristics may also include medical conditions for which the care plan may provide treatment, as well as an indicated effectiveness for treating the condition. In an embodiment, the indicated effectiveness may be derived using historical data relating to the treatment of previous patients at a medical facility. Care plan characteristics may also include a planned duration of treatment, as well as treatment goals.

In act 104, the identified care plans are designated as candidate care plans. The designation may be made when at least one patient care plan characteristic matches at least one clinical characteristic of the patient. The designation may be made by any technique. For example, a care plan may be flagged for further processing or consideration as a designation.

Clinical characteristics may involve any characteristic relating to a condition of the patient. For example, clinical characteristics may involve problems or symptoms of a patient, allergies of a patient, or a diagnosis of a patient. In an embodiment, a diagnosis of a condition of a patient is matched to an indication that a care plan may be suitable for treating the diagnosed condition. For example, a diagnosis code of a condition for a patient may be matched to a diagnosis code associated with each of the care plans.

Further, the care plan effectiveness for treating the diagnosed condition may have been assessed based on specified goals for treatment of the condition. For example, as indicated in FIG. 2, a diagnosed condition may be chronic kidney disease and a specified goal may be a Hematocrit percentage greater than 33% as achieved for a quality measure 420 for a care plan. Care plans for the treatment of chronic kidney disease may be designated as a candidate care plan if the care plan has historically achieved the 33% hematocrit goal. In an embodiment, the historical achievement of the goal may be evaluated based on treatment performed in a facility that will execute an ultimately selected care plan for a patient. In an embodiment, the effectiveness evaluation may indicate that a care plan has met goals and is effective for treatment of particular conditions.

In act 106, the compatibility of the candidate care plans with the patient may be assessed. The compatibility may be assessed using any technique capable of determining that a patient may be eligible and/or able to undergo the care plan.

In an embodiment, assessing the compatibility may involve comparing a medication associated with a care plan component of the at least one candidate care plan with a medication allergy of the patient.

In an embodiment, assessing the compatibility may involve comparing an insurance coverage status of a component of the at least one candidate care plan with an insurance coverage of the patient. In an embodiment, historical treatment data may indicate that a care plan, or care plan components, were previously found compatible with the insurance of a patient, or that the patient meets the eligibility requirements for the insurance. A compatibility determination may be made based on such historical treatment data. In an embodiment, the candidate care plans may be submitted to the insurance provider of the patient for verification of coverage, or verification for the eligibility of a patient for coverage.

In an embodiment, individual procedure and medication components may be found to not meet eligibility requirements for a patient. In such a case, alternative components may be provided. The alternative components may be indicated by historical treatment data for a facility. For example, historical treatment data may indicate that alternate components have successfully provided comparable treatment, and/or that the alternative components have historically been covered by the insurance of the patient.

The compatibility assessing may involve replacing the care plan component with an alternate care plan component associated with a different medication when an incompatibility is established based on the comparison. When the component insurance coverage status indicates that the component is not associated with the insurance coverage of the patient, the assessing may involve replacing the component with a comparable component that is associated with the insurance coverage of the patient.

In act 108, a cost of care plans may be determined. The cost of the care plans may be based on the costs of the care plan components. Costs may be determined for the individual care plans deemed to be compatible with the patient. A total cost for the complete execution of a care plan may be determined by summing the resultant costs of each care plan component included in the care plan. Further, the care plan costs may be determined based on a periodic payment or per treatment occurrence rate. For example, a care plan cost may involve dialysis components, and a cost per dialysis treatment may be determined. In an embodiment, care plans may be modified to include alternate components, having different costs that the original component. As such, a care plan may have costs determined after alternate components have been included. In an embodiment, act 108 may occur before and after any of act 102, act 104, or act 106. Further, a care plan may have costs established prior to act 102, act 104, or act 106, and then re-determined after act 102, act 104, or act 106.

In act 110, the compatible candidate care plans may be provided to a user. The compatible candidate care plans may be presented along with the indicated effectiveness for treating conditions of the specific candidate care plans and/or associated costs of the specific candidate care plans. The care plans may be provided using any technique capable of providing a user with information regarding the compatible candidate care plans. In an embodiment, the compatible candidate care plans may be displayed as a list with associated data using a workstation 406 as described with respect to FIG. 2.

Further, a user may select a care plan of the candidate care plans to be associated with the treatment of a patient. Similarly, the selection may be performed using the workstation 406.

FIG. 2 illustrates an embodiment of patient care plan determination. A repository of data 402 contains historical treatment data and/or a collection of care plans. The historical treatment data may involve recorded results of patients that have undertaken specific care plans, or care plan components, of the collection of care plans. The care plans may have been executed at a particular facility, or multiple facilities. A user may access the repository of data 402 using a workstation 406, which may be implemented using structure as described with respect to the system 10 of FIG. 4.

The user may enter topical characteristics for a patient, such as age, gender, ethnicity, geographical location, and insurance coverage, into the workstation 406. The user may also enter patient clinical characteristics using the workstation 406. The user may then access the repository of data 402 using the workstation 406 to determine patient care plan options 410, 412 for a patient diagnosed with chronic kidney disease. Based on the provided characteristics, two care plans 410, 412 may be provided to a user. The repository of data 402 may include a collection of care plans, each having associated characteristics and data. In an embodiment, the repository of data 402 may be a central data repository for current and historical data relating to care plans structured as a relational database management system.

The care plans 410, 412 may be similar, but include different components. For example, both care plans 410, 412 may include dialysis, however one of the care plans 412 may also include a component for injectable drugs.

Other information may also be provided with the care plans 410, 412. The other information may include treatment duration 414 indicating the expected duration of the treatment. The other information may involve a frequency of care 416 required for a care plan. The other information may also involve cost 418 and quality measure 420 of the particular care plans 410, 412.

The costs 418 may be presented in a totaled format, such as a cost for participation throughout the entire care plan, or may be in another format appropriate to provide an indication of costs to be incurred by a patient that undergoes the care plan, such as cost by time period or component costs. In an embodiment, a care plan may be put into place perpetually, and as such the costs 418 may be displayed at a rate required, such as a cost per visit to a facility for treatment.

The quality measures 420 may be established measurements for determining the effectiveness of a care plan for treating a particular condition. For example, a Urea Reduction Ratio (“URR”) may be measured as an indicator of the effectiveness of a patient care plan chosen for treating a patient with chronic kidney disease. Further, an established goal or threshold for a determination of whether a care plan is effective may also be presented. For example, a URR of greater than or equal to 65% may be an effectiveness threshold. Also, a care plan's actual historical value for the effectiveness measure may also be provided. For example, a care plan 410 may have a historical URR of 67% found to be the average value for patients undergoing the care plan at a facility, or multiple facilities. In this way, the effectiveness of provided care plans 410, 412 for treating a condition may be compared directly at a point when a care plan is being chosen for a patient.

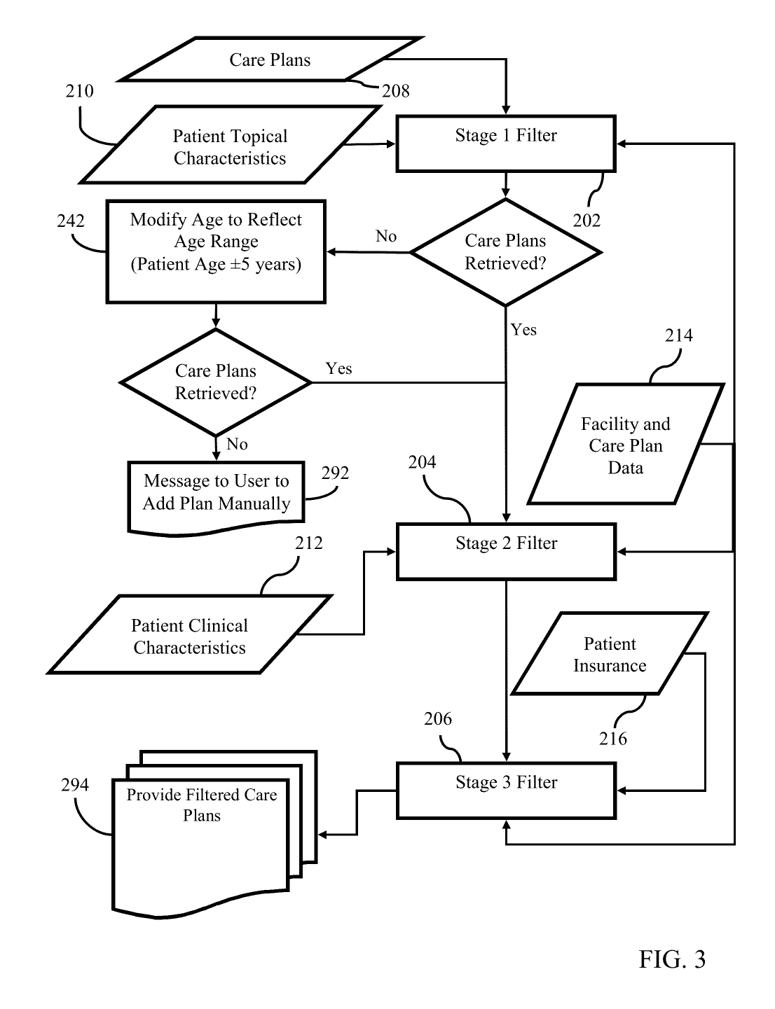

FIG. 3 shows a flow chart diagram of one embodiment of a method for patient care plan determination. Patient topical characteristics 210 may be used to filter care plans from a collection of care plans 208 using various stages of filters 202, 204, 206. Any number of filtering stages may be provided, such as one, two, three, or more. The filters may be operational to process multiple care plans of the collection of care plans 208. For example, the collection of care plans 208 may involve hundreds or thousands of care plans that may be processed through the filters 202, 204, 206. In an embodiment, the filtering is part of the implementation of the FIG. 1, such as filtering being part of acts 102, 104, and 106. Such significant processing volume may be performed by a computer or processor in a relatively short time, such as within seconds, a minute, or a few minutes, to create representative transaction data sets for each transaction using structure as described with respect to the system 10 of FIG. 4. In this way, care plans particularly suited to a patient may be provided quickly, or in real-time as data related to a patient is input into a system. For example, provided options for care plans for a patient may be modified based on data input into a system relating to a patient, as each additional portion of data is input. Thus, a dynamic presentation of care plans for a patient may be provided.

Similar to act 102 of FIG. 1, the stage 1, or primary, filter 202 may operate by filtering on the patient topical characteristics 202, such as gender or age, and match those characteristics to applicable characteristics associated with care plans indicated from care plan data 214. For example, care plans associated with male patients will be passed through the stage 1 filter 202 when the patient topical characteristics 210 indicate that the patient is male. In an embodiment, the stage 1 filter 202 passes care plans through the filter only if the care plan characteristics match both the age and gender of a patient.

In an embodiment, if no care plans are passed through the stage 1 filter 202, a patient's age may be modified to reflect an age range of the patient. For example, a value for the age defining a range five years older and five years younger than the patient may be used for an age characteristic. This increased age range value increases the possibility of a care plan applicable to the patient's age group being selected through the stage 1 filter 202. If still no care plans are passed through the stage 1 filter, a message 292 may be provided to a user indicating that a care plan must be manually created. If the increased patient age range does result in care plan options passing through the stage 1 filter, the care plan options are passed to the stage 2, or intermediate, filter 204. Such age range expansion may also be used if no care plans pass a stage 1 filter 202 requiring both an age and gender of a patient be matched.

Similar to act 104 of FIG. 1, a stage 2, or intermediate, filter 204 may involve matching facility and care plan specific data 214 with patient clinical characteristics 212 to determine care plans that may pass through the filter. For example, a diagnosis of a condition for a patient may be provided as patient clinical characteristics 212, and the care plans that pass through the stage 2 filter 204 may be designated as appropriate for treating the diagnosed condition. The designation may be accomplished through any technique. For example, care plans may be associated in a table with appropriate conditions. Also, a diagnosis code of a diagnosed condition for a patient may be used to determine care plans that have an associated matching diagnosis code, and pass the matching diagnosis code care plans through the filter.

The stage 2 filter 204 may also use other facility and care plan data 214. Other facility and care plan data may involve treatment goals for conditions, and plans that pass through the filter may have been historically found to meet the treatment goals. Further, the data indicating historical success in meeting goals may be from a specific facility treating a patient. In an alternate embodiment, the historical goal data for care plans may be derived from data of the treatment of patients from multiple facilities. Also, the quality measures may be regulatory quality measures, established by a regulatory body or organization. The regulatory quality measures may be indicated as quality of care measures for rating the quality of care of specific facilities.

Other facility and care plan data 214 may also involve care plan cost data. In an embodiment, care plans having a cost that does not meet a threshold are not passed through a filter. For example, if a cost threshold is $15,000, only care plans having a cost of equal or less than $15,000 may be passed through the filter. In another example, only care plans having a cost equal to or more than the threshold may be passed through the stage 2 filter 204.

Patient clinical characteristics 212 may also involve incompatibility data. For example, a patient with a severely sprained ankle will not be able to partake in a rehabilitation module of a care plan involving required running. The stage 2 filter 204 may identify incompatibilities and select different care plans, or modify existing care plan modules with alternative modules, accordingly. In the above example, an alternate care plan involving swimming or other low ankle impact rehabilitation may be selected to pass through the stage 2 filter. Also, the running rehabilitation module of an existing care plan may be replaced with swimming or another low ankle impact rehabilitation module as an alternative.

In an embodiment, the patient clinical characteristics involve an incompatibility with a medication, such as an allergy. The stage 2 filter 204 may only allow care plans that do not match the incompatibility to pass through the filter. Alternatively, the stage 2 filter 204 may identify the medication incompatibility in a care plan and replace the incompatible medication component with an alternate compatible medication component.

Alternates for care plan components may be determined using any technique. In an embodiment, component alternatives may be listed and associated together in an associative database such that alternatives may be identified. Further, a table of alternative associations may be provided. In an embodiment, specific alternative repositories, such as Procedure & Drugs Repositories (“PDR”) may provide for care plan and care plan component alternatives when an incompatibility is identified.

In an embodiment, if no care plans are passed through the stage 2 filter 204, a message may be provided to a user to manually create a care plan.

The care plans that pass through the stage 2 filter 204, may be additionally processed by the stage 3, or advanced, filter 206. Similar to act 106 of FIG. 1, the stage 3 filter 206 may involve comparing further facility and care plan data 214 and other patient data, such as patient insurance data 216. In an embodiment, the stage 3 filter 206 may identify an incompatibility between patient insurance data 216 and insurance information contained in the facility and care plan data 214 for care plans passed to the stage 3 filter 206. For example, care plan data 214 may involve insurance coverage data associated with care plans. Patient insurance coverage data 216 may be matched to the insurance coverage data associated with care plans to determine which care plans pass through the stage 3 filter. For example, only care plans that indicate that a patient would have the components of the care plan covered by the patient's insurance coverage would be passed through the stage 3 filter 206.

The resulting filtered care plans 294 may be provided for specific care plan selection for a patient. For example, the filtered care plans may be provided to a user for manual selection of an appropriate care plan for a patient. Alternatively, care plans having care plan components not covered, or only partially covered, by the patient insurance would be passed through the filter, but have patient costs associated with the not covered, or partially covered components. As such, a cost for a care plan may be the cost to a patient of the care plan after insurance coverage is taken into account.

In an embodiment, the stage 3 filter 206 may identify an incompatibility with the patient insurance data 216 and care plan insurance coverage data of care plans passed to the stage 3 filter 206. The stage 3 filter 206 may identify alternative care plans or care plan components that do not present such an incompatibility. In an embodiment, the care plan and/or care plan component alternatives may be provided to a user for selection, and the resulting care plans with selected alternatives may be provided to a user for selection of a particular care plan for a patient.

In an embodiment, when no care plans are passed through the stage 3 filter 206, a message may be provided to a user to manually create a care plan for a patient.

After selection of a care plan for a patient, the care plan may be implemented and associated with the patient in a healthcare system. Further, the progress of the patient through the care plan may be updated with data acquired during execution of the care plan. For example, patient specific values may be compared to goal values for care plan components. The updated patient data may in turn be used for future care plan determinations for future patients.

In an embodiment, the filtered staging is not indicative of the order of application of the filters. For example, a diagnosed condition may be provided in patient clinical characteristics 212 at the same time or prior to the entry of patient topical characteristics 210. As such, the stage 1 filter 202 and the stage 2 filter 204 may operate to filter the care plans 208 at the same time. Further, the stage 2 filter 204 may be applied prior to the stage 1 filter 202. Also, the stage 3 filter 206 may be applied prior to, or concurrently with, the stage 1 filter 202 and the stage 2 filter 204.

FIG. 4 provides an illustrative embodiment of a computer system 10 for preparation of a data set for healthcare system development. The computer system 10 can include a set of instructions that can be executed to cause the computer system 10 to perform any one or more of the methods or computer based functions disclosed herein. The computer system 10 may operate as a standalone device or may be connected, e.g., using a network, to other computer systems or peripheral devices. Any of the embodiments discussed above may be implemented using the computer system 10, multiple computer systems 10, or a component in the computer system 10.

In a networked deployment, the computer system 10 may operate in the capacity of a server or as a client user computer in a client-server user network environment, or as a peer computer system in a peer-to-peer (or distributed) network environment. The computer system 10 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 10 can be implemented using electronic devices that provide voice, video or data communication. Further, while a single computer system 10 is illustrated, the term “system” shall also be taken to include any collection of systems or sub-systems that individually or jointly execute a set, or multiple sets, of instructions to perform one or more computer functions.

As illustrated in FIG. 4, the computer system 10 may include a processor 12, e.g., a central processing unit (CPU), a graphics processing unit (GPU), or both. The processor 12 may be a component in a variety of systems. For example, the processor 12 may be part of a standard personal computer or a workstation. The processor 12 may be one or more general processors, digital signal processors, application specific integrated circuits, field programmable gate arrays, servers, networks, digital circuits, analog circuits, combinations thereof, or other now known or later developed devices for analyzing and processing data. The processor 12 may implement a software program, such as code generated manually (i.e., programmed).

In an embodiment, the processor 12 may be configured to cause the system 10 to identify patient care plans from a collection of patient care plans based on topical characteristics of the patient. The processor 12 may be further configured to cause the system 10 to designate identified care plans as a candidate care plans when a care plan characteristic matches a clinical characteristic of the patient. The processor 12 may be further configured to cause the system 10 to assess the compatibility of the at least one candidate care plan with the patient. The processor 12 may be further configured to cause the system 10 to determining a cost of the candidate care plans deemed to be compatible with the patient, the cost based on the costs of the care plan components, and provide the compatible candidate care plans to a user.

In another embodiment, a processor 12 may be implemented, with other necessary components, as a care plan processor configured for using the historical treatment data in selecting candidate care plans for treating a diagnosed condition of a patient in response to the clinical quality indicators, analyzing the selected care plans to identify a medication interaction and a conflict with a patient allergy, identifying candidate alternative medications using predetermined data identifying medications and their alternatives and using the historical treatment data in identifying costs of individual procedures and medications of the selected care plans and the alternatives.

Alternatively, a care plan processor may be configured for using the historical treatment data in selecting candidate care plans for treating a diagnosed condition of a patient in response to the historical treatment data indicating a care plan of treatment brings a patient tested parameter to a normal value for patients having the condition, using the historical treatment data in identifying costs of individual procedure components and medication components of the selected care plans, initiating insurance eligibility verification for the patient for the selected care plans and costs of individual procedure components and medication components.

In an embodiment, the clinical quality indicators involve a laboratory test result indicating a patient tested parameter shows an abnormal value for the patient. The care plan processor may then select a candidate care plan for treating a diagnosed condition of a patient in response to the historical treatment data indicating a care plan of treatment brings a patient tested parameter to a normal value for patients concerned.

In an embodiment, the care plan processor may analyze the selected care plans to identify a medication interaction and a conflict with a patient allergy and identifies candidate alternative medications using predetermined data identifying medications and their alternatives.

Further, a processor 12 may be implemented with other necessary components as an output processor configured for providing message data to a user identifying the selected care plans and the alternatives and costs of individual procedures and medications and the alternatives.

Other necessary components may be a display 16, memory 14, or any other component necessary to implement the processor 12 as indicated.

The computer system 10 may include a memory 14 that can communicate via a bus 20. The memory 14 may be a main memory, a static memory, or a dynamic memory. The memory 14 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 14 includes a cache or random access memory for the processor 12. In alternative embodiments, the memory 14 is separate from the processor 12, such as a cache memory of a processor, the system memory, or other memory. The memory 14 may be an external storage device or database for storing data. Examples include a hard drive, compact disc (“CD”), digital versatile disc (“DVD”), memory card, memory stick, floppy disc, universal serial bus (“USB”) memory device, or any other device operative to store data. The memory 14 is operable to store instructions executable by the processor 12. The functions, acts or tasks illustrated in the figures or described herein may be performed by the programmed processor 12 executing the instructions 22 stored in the memory 14. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The instructions 22 may be operable to cause the system 10 to identify at least one patient care plan from a plurality of patient care plans based on topical characteristics of the patient, wherein the plurality of patient care plans comprise care plan components and care plan characteristics and the care plan components are associated with a cost, designate at least one identified care plan as a candidate care plan when at least one patient care plan characteristic matches at least one clinical characteristic of the patient, assess the compatibility of the at least one candidate care plan with the patient, and provide the at least one compatible candidate care plan and associated cost to a user.

As shown, the computer system 10 may further include a display unit 16, such as a liquid crystal display (LCD), an organic light emitting diode (OLED), a flat panel display, a solid state display, a cathode ray tube (CRT), a projector, a printer or other now known or later developed display device for outputting determined information. The display 16 may act as an interface for the user to see the functioning of the processor 12, or specifically as an interface with the software stored in the memory 14 or in the drive unit 25.

In an embodiment, the display 16 may be operable to present care plans to a user of the system 10.

Additionally, the computer system 10 may include an input device 18 configured to allow a user to interact with any of the components of system 10. The input device 18 may be a number pad, a keyboard, or a cursor control device, such as a mouse, or a joystick, touch screen display, remote control or any other device operative to interact with the system 10. The input device 18 may be used by a user to select a patient care plan and/or care plan components.

In a particular embodiment, as depicted in FIG. 4, the computer system 10 may also include a disk or optical drive unit 25. The disk drive unit 25 may include a computer-readable medium 410 in which one or more sets of instructions 22, e.g. software, can be embedded. Further, the instructions 22 may embody one or more of the methods or logic as described herein. In a particular embodiment, the instructions 22 may reside completely, or at least partially, within the memory 14 and/or within the processor 12 during execution by the computer system 10. The memory 14 and the processor 12 also may include computer-readable media as discussed above.

In an embodiment, the memory 12 or the computer readable medium 24 may be operable to store a collection of patient care plans and/or care plan components as well as historical data relating to the care plan components.

The present disclosure contemplates a computer-readable medium that includes instructions 22 or receives and executes instructions 22 responsive to a propagated signal, so that a device connected to a network 30 can communicate video, audio, images, text, or any other data over the network 30. Further, the instructions 22 may be transmitted or received over the network 30 via a communication interface 26. The communication interface 26 may be a part of the processor 12 or may be a separate component. The communication interface 26 may be created in software or may be a physical connection in hardware. The communication interface 26 is configured to connect with a network 30, external media, the display 16, or any other components in system 10, or combinations thereof. The connection with the network 30 may be a physical connection, such as a wired Ethernet connection or may be established wirelessly as discussed below. Likewise, the additional connections with other components of the system 10 may be physical connections or may be established wirelessly.

The network 30 may include wired networks, wireless networks, or combinations thereof. The wireless network may be a cellular telephone network, an 802.11, 802.16, 802.20, or WiMax network. Further, the network 30 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), or a tablet device, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I (we) claim:

1. A method for patient care plan determination for a patient, the method comprising:
identifying, with a processor, at least one patient care plan from a plurality of patient care plans based on topical characteristics of the patient, wherein the plurality of patient care plans comprise care plan components and care plan characteristics, the care plan characteristics comprise an indicated effectiveness for treating conditions, and the care plan components are associated with a cost;
designating at least one identified care plan as a candidate care plan when at least one patient care plan characteristic matches at least one clinical characteristic of the patient;
assessing the compatibility of the at least one candidate care plan with the patient;
determining a cost of the at least one candidate care plan deemed to be compatible with the patient, the cost based on the costs of the care plan components; and
providing in real-time the at least one compatible candidate care plan to a user, the providing comprising providing the indicated effectiveness for treating conditions of the candidate care plan and associated cost of the candidate care plan.

2. The method of claim 1, wherein the topical patient characteristics comprise a patient age, a patient gender, a patient ethnicity or race, patient physiological findings, patient mobility, patient habits, or patient geographical location.

3. The method of claim 1, wherein the matching care plan characteristic and clinical characteristic is a diagnosis of a condition of patient.

4. The method of claim 3, wherein the designated at least one care plan effectiveness for treating the condition has been assessed based on specified goals.

5. The method of claim 3, wherein the designated at least one care plan has been deemed effective for treating the condition.

6. The method of claim 1, wherein the assessing comprises comparing a medication associated with a care plan component of the at least one candidate care plan with a medication allergy of the patient, and replacing the care plan component with an alternate care plan component associated with a different medication when an incompatibility is established based on the comparison.

7. The method of claim 1, wherein the assessing comprises comparing an insurance coverage status of a component of the at least one candidate care plan with an insurance coverage of the patient, and when the component insurance coverage status indicates that the component is not associated with the insurance coverage of the patient, replacing the component with a comparable component that is associated with the insurance coverage of the patient.

8. The method of claim 1, wherein the care plan component costs are costs derived from historical data relating to the treatment of previous patients at a facility treating the patient.

9. The method of claim 1, wherein the indicated effectiveness for treating conditions of the candidate care plan are derived using historical data relating to the treatment of previous patients at a facility treating the patient.

10. A non-transitory computer readable storage medium having stored therein data representing instructions executable by a programmed processor for preparation of a data set for patient care plan determination for a patient, the storage medium comprising instructions for:
identifying at least one patient care plan from a plurality of patient care plans based on topical characteristics of the patient, wherein the plurality of patient care plans comprise care plan components and care plan characteristics and the care plan components are associated with a cost;
designating at least one identified care plan as a candidate care plan when at least one patient care plan characteristic matches at least one clinical characteristic of the patient;
assessing the compatibility of the at least one candidate care plan with the patient; and
providing the at least one compatible candidate care plan and associated cost to a user.

11. The media of claim 10, wherein the topical patient characteristics comprise a patient age, a patient gender, a patient ethnicity or race, patient physiological findings, patient mobility, patient habits, or patient geographical location.

12. The medium of claim 10, wherein the matching care plan characteristic and clinical characteristic is a diagnosis of a condition of patient.

13. The medium of claim 12, wherein the designated at least one care plan effectiveness for treating the condition has been assessed based on specified goals.

14. The medium of claim 13, wherein the designated at least one care plan has been deemed effective for treating the condition.

15. The medium of claim 10, wherein the assessing comprises comparing a medication associated with a care plan component of the at least one candidate care plan with a medication allergy of the patient, and replacing the care plan component with an alternate care plan component associated with a different medication when an incompatibility is established based on the comparison.

16. The medium of claim 10, wherein the assessing comprises comparing an insurance coverage status of a component of the at least one candidate care plan with an insurance coverage of the patient, and when the component insurance coverage status indicates that the component is not associated with the insurance coverage of the patient, replacing the component with a comparable component that is associated with the insurance coverage of the patient.

17. The medium of claim 10, wherein the care plan component costs are costs derived from data relating to the treatment of previous patients at a facility treating the patient.

18. A system for patient care plan determination, the system comprising:
at least one repository of historical treatment data comprising a plurality of care plans and associated treatment objectives and treatment costs and diagnoses associated with clinical quality indicators and costs;
a care plan processor for automatically,
using the historical treatment data in selecting candidate care plans for treating a diagnosed condition of a patient in response to the clinical quality indicators,
analyzing the selected care plans to identify a medication interaction and a conflict with a patient allergy,
identifying candidate alternative medications using predetermined data identifying medications and their alternatives and
using the historical treatment data in identifying costs of individual procedures and medications of the selected care plans and the alternatives; and
an output processor for providing message data to a user identifying the selected care plans and the alternatives and costs of individual procedures and medications and the alternatives.

19. A system according to claim 18, wherein the care plan processor submits the selected care plans and the alternatives and costs of individual procedures and medications and the alternatives for insurance eligibility verification for the patient.

20. A system according to claim 19, wherein in response to at least one of, the individual procedures and medications and the alternatives not meeting insurance eligibility requirements, the care plan processor uses the historical treatment data in identifying care plan medications and procedure alternatives meeting insurance eligibility requirements for the patient.

21. A system according to claim 18, wherein the care plan processor uses the historical treatment data in identifying care plans meeting insurance eligibility requirements for the patient.

22. A system according to claim 18, wherein the care plan processor analyzes the selected care plans and the alternatives and costs of individual procedures and medications and the alternatives for insurance eligibility verification for the patient.

23. A system according to claim 22, wherein in response to at least one of, the individual procedures and medications and the alternatives not meeting insurance eligibility requirements, the care plan processor uses the historical treatment data in identifying care plan medications and procedure alternatives meeting insurance eligibility requirements for the patient.

24. A system according to claim 18, wherein the clinical quality indicators comprise a laboratory test result indicating a patient tested parameter shows an abnormal value for the patient, and the care plan processor selects a candidate care plan for treating a diagnosed condition of a patient in response to the historical treatment data indicating a care plan of treatment brings a patient tested parameter to a normal value for patients concerned.

25. A system according to claim 18, wherein the care plan processor selects a candidate care plan by selecting a care plan that has historically achieved a treatment goal of the care plan.

26. A system according to claim 18, wherein the care plan processor selects the candidate care plans for treating a diagnosed condition by filtering care plans in the historical treatment data by patient age and gender.

27. A system according to claim 26, wherein the care plan processor selects the candidate care plans for treating a diagnosed condition by filtering care plans in the historical treatment data by diagnosis code.

28. A patient care plan determination system, comprising:
at least one repository of historical treatment data comprising a plurality of care plans and associated treatment objectives and treatment costs and diagnoses associated with clinical quality indicators and costs;
a care plan processor for:
using the historical treatment data in selecting candidate care plans for treating a diagnosed condition of a patient in response to the historical treatment data indicating a care plan of treatment brings a patient tested parameter to a normal value for patients having the condition;
using the historical treatment data in identifying costs of individual procedure components and medication components of the selected care plans;
initiating insurance eligibility verification for the patient for the selected care plans and costs of individual procedure components and medication components; and
an output processor for providing message data to a user identifying the selected care plans and the alternatives and costs of individual procedure components and medication components and the alternative components.

29. A system according to claim 28, wherein the care plan processor analyzes the selected care plans to identify a medication interaction and a conflict with a patient allergy and identifies candidate alternative medications using predetermined data identifying medications and their alternatives.
